(19) United States
(12) Patent Application Publication
(10) Pub. No.: US 2009/0214325 A1
(43) Pub. Date: Aug. 27, 2009

(54) INTERCHANGEABLE TRUCK RAIL-RAMPS WITH ENHANCED SURFACE TRACTION

(76) Inventor: Gary A. White, Riverbank, CA (US)

Correspondence Address: NW-IP-LAW, 6039 E. Grant RD., Tucson, AZ, 85712, US

(21) Appl. No.: 12/038,120

(22) Filed: Feb. 27, 2008

(51) Int. Cl. B62D 33/027

(52) U.S. Cl. 414/537

(57) ABSTRACT

The present invention is directed to a set of interchangeable truck rails for providing an enclosure on the back of a flat bed truck including a first rail, a second, a set of attaching devices, and a set of traction devices to allow a person to enclose the back of a flat bed truck, as well as providing a set of ramps for moving large items onto the back of the flat bed truck. The ramps have enhanced tractions.

### BACKGROUND OF THE INVENTION

The present invention is directed to a set of interchangeable truck rails for providing an enclosure on the back of a flat bed truck including a first rail, a second, a set of attaching devices, and a set of traction devices to allow a person to enclose the back of a flat bed truck, as well as providing a set of ramps for moving large items onto the back of the flat bed truck. One of the novel features of the present invention is the enhanced surface traction.

### BRIEF DESCRIPTION OF THE DRAWINGS

FIG. 1 is an illustration of a set of interchangeable truck rails according to the invention including a first rail and a second rail.

FIG. 2 is an illustration of the interchangeable truck rails being used as truck ramps including a first rail, a second rail, and traction devices (see insert).

FIG. 3 is a side cross section view of the ramps of FIG. 2 as attached to the side of flat bed truck.

FIG. 4 is an end cross section view of the ramps of FIG. 2.

### DESCRIPTION OF PREFERRED EMBODIMENTS

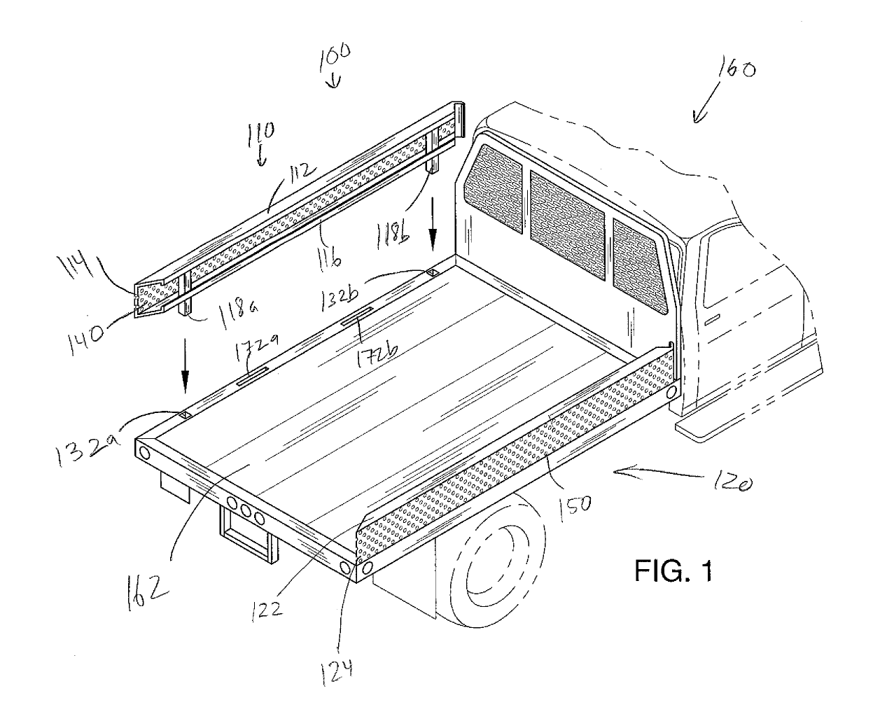

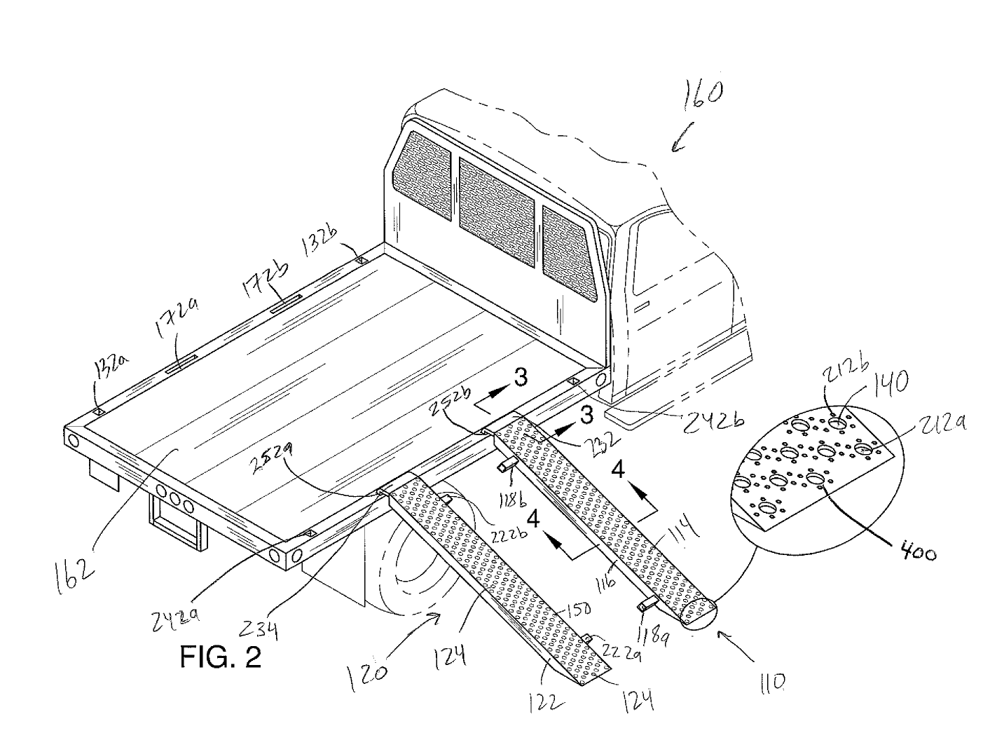

Referring now to FIG. 1, interchangeable truck rails 100 comprise first rail 110 and second rail 120. In the illustrated embodiment of FIG. 1, first rail 110 comprises first side 112, second side 114, third side 116, first attachment member 118a, second attachment member 118b, and traction devices 140. In the illustrated embodiment of FIG. 1, second rail 120 comprises first side 122, second side 124, and traction devices 150. In the illustrated embodiment of FIG. 1, first rail 110 is attached to the left side of flat bed 162 by encasing first attachment member 118a in receiving aperture 132a and encasing second attachment member 118b in receiving aperture 132b. In the illustrated embodiment of FIG. 1, second rail 120 is attached to the right side of flat bed 162 by encasing third attachment member 222a in receiving aperture 242a (see FIG. 2). In the illustrated embodiment of FIG. 1, second rail 120 is attached to the right side of flat bed 162 by encasing fourth attachment member 222b in receiving aperture 242b (see FIG. 2).

The ramp of the present invention is unique in that it provides for enhanced traction. In the illustrated embodiment of FIG. 1, traction devices 140 and traction devices 150 comprise a first aperture surrounded by a series of six circular protrusions (see FIG. 2). In some embodiments, the protrusions are positioned symmetrically around the central aperture. During snowy weather, snow can fall through first aperture 212a to rid the snow between the tire and the ramp, while series of six circular protrusions 212b provide a greater traction for items that are moved up the ramps due to the placement of the series of six circular protrusions 212b on the ramps.

In certain embodiments, first rail 110 and second rail 120 can attach to the side of flat bed truck 160 to be used as ramps by inserting first truck attachment member 232 and second truck attachment member 234 into first slot 1 72a and second slot 172b, respectively (see FIG. 2). In certain embodiments, interchangeable truck rails 100 are used on pickups, trailers, and the like.

In certain embodiments, first rail 110 comprises a rigid material selected from the group consisting of metal, plastic, wood, or combinations thereof. In certain embodiments, first rail 110 comprises a length between about 6 feet and about 12 feet. In certain embodiments, first rail 110 comprises a width between about 10 inches and about 18 inches. In certain embodiments, first rail 110 comprises a height between about 3 inches and about 6 inches. In certain embodiments, first attachment member 118a comprises a rigid material selected from the group consisting of metal, plastic, wood, or combinations thereof. In certain embodiments, first attachment member 118a comprises an elongated member with a rectangular cross section. In certain embodiments, second attachment member 118b comprises a rigid material selected from the group consisting of metal, plastic, wood, or combinations thereof. In certain embodiments, second attachment member 118b comprises an elongated member with a rectangular cross section. In certain embodiments, second rail 120 comprises a rigid material selected from the group consisting of metal, plastic, wood, or combinations thereof. In certain embodiments, second rail 120 comprises a length between about 6 feet and about 12 feet. In certain embodiments, second rail 120 comprises a width between about 10 inches and about 18 inches. In certain embodiments, second rail 120 comprises a height between about 3 inches and about 6 inches. In certain embodiments, first rail 110 and second rail 120 comprise an expanded metal mesh design with downward-curved outer edges for strength and rigidity.

Referring now to FIG. 2, interchangeable truck rails 100 comprise first rail 110 and second rail 120. In the illustrated embodiment of FIG. 2, first rail 110 comprises second side 114, third side 116, first attachment member 118a, second attachment member 118b, traction devices 140, and first truck attachment member 232. In the illustrated embodiment of FIG. 1, second rail 120 comprises first side 122, second side 124, third attachment member 222a, fourth attachment member 222b, second truck attachment member 234, and traction devices 150. In the illustrated embodiment of FIG. 1, first rail 110 is removed from the left side of flat bed 162. In the illustrated embodiment of FIG. 2, first rail 110 is attached to flat bed truck 160 by attaching first rail 110 to third slot 252a by inserting first truck attachment member 232 into slot 252a. In the illustrated embodiment of FIG. 2, second rail 120 is attached to the flat bed truck 160 by attaching second rail 120 to fourth slot 252b by inserting second truck attachment member 234 into slot 252b. In certain embodiments, first rail 110 and second rail 120 are inserted into first slot 172a and second slot 172b, respectively.

In the illustrated embodiment of FIG. 2, second rail 120 is attached to the right side of flat bed 162 by encasing third attachment member 222a in receiving aperture 242a. In the illustrated embodiment of FIG. 2, second rail 120 is attached to the right side of flat bed 162 by encasing fourth attachment member 222b in receiving aperture 242b. In the illustrated embodiment of FIG. 2, traction devices 140 and traction devices 150 comprise a first aperture 212a surrounded by a series of six circular protrusions 212b. A person can use first rail 110 and second rail 120 as ramps. The ramps provide greater traction due to the traction devices 140 and traction devices 150. During snowy weather, snow can fall through first aperture 212a, while series of six circular protrusions 212b provide a greater traction for items that are moved up the ramps due to the placement of the series of six circular protrusions 212b on the ramps. In some embodiments, the protrusions are about ⅛ to about ¼ inch high from base 300 to peak 302. In some embodiments, the protrusion is circular from the top view and has a radius of about 1/16 to about ¼ inch. In some embodiments, the outer edge of the base of each protrusion is about ¼ to about ½ inch from the edge 400 of the aperture. In some embodiments, the aperture is circular from the top view, and has a radius of about ¼ to about ¾ inch.

In certain embodiments, third attachment member 222a comprises a rigid material selected from the group consisting of metal, plastic, wood, or combinations thereof. In certain embodiments, third attachment member 222a comprises an elongated member with a rectangular cross section. In certain embodiments, fourth attachment member 222b comprises a rigid material selected from the group consisting of metal, plastic, wood, or combinations thereof. In certain embodiments, fourth attachment member 222b comprises an elongated member with a rectangular cross section.

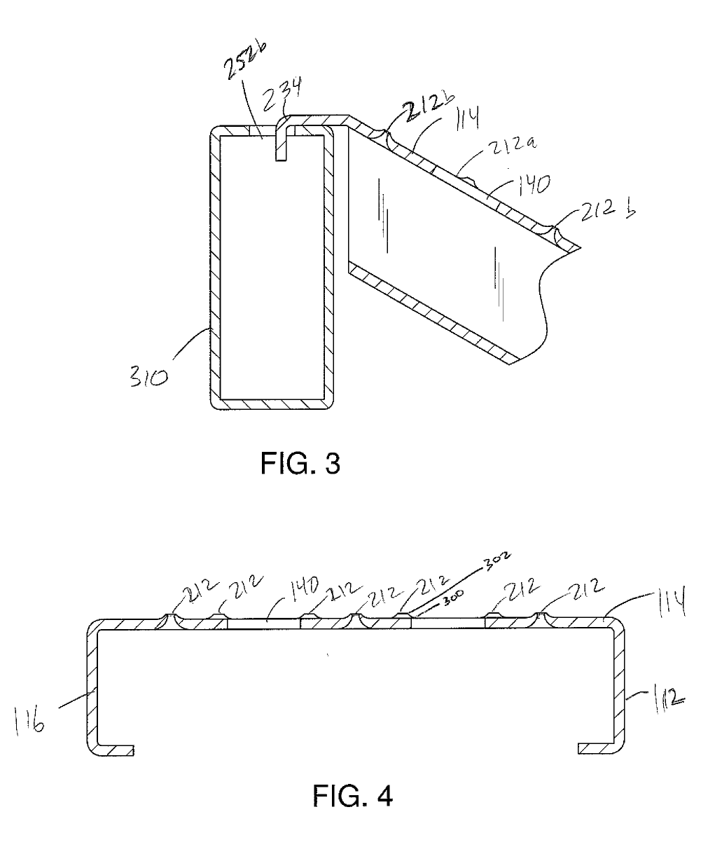

Referring now to FIG. 3, a side cross section view of first rail 110 is shown attached to flat bed truck 160. In the illustrated embodiment of FIG. 3, first truck attachment member 234 is inserted into third slot 252b to secure first rail 110 to the side of flat bed truck 160. In the illustrated embodiment of FIG. 3, traction devices 140 comprise a first aperture 212a surrounded by a series of six circular protrusions 212b.

Referring now to FIG. 4, an end view of first rail 110 is shown comprising first side 112, second side 114, third side 116, and traction devices 140. In the illustrated embodiment of FIG. 4, traction devices 140 are molded into second side 114 to form a more enhanced traction system for vehicles that are moved up first rail 110 and second rail 120.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A set of interchangeable truck rails, comprising:
a first rail, said first rail comprising a first side, a second side, a third side, a first attachment post, a second attachment post, and a first attachment device, said first side, said second side, and said third side of said first rail molded together to form one member, said second side comprising a set of traction devices, said traction devices comprising a central aperture and a series of six circular protrusions positioned around said central aperature, said central aperture and said series of six circular protrusions dispersed along said second side of said first rail, said first rail removeably attached to a flatbed of a truck by inserting in a downward direction said first attachment post and said second attachment post into a first receiving aperture and a second receiving aperture, said first rail being removed by lifting said first attachment post and said second attachment post from within said first receiving aperture and said second receiving aperture, said first rail can be removeably attached to said flatbed of said truck as a first ramp by inserting said first attachment device into a first slot located on a most outer edge of said flatbed of said truck and letting said first rail rest on the ground beside said flatbed of said truck,
a second rail, said second rail comprising a first side, a second side, a third side, a first attachment post, a second attachment post, and a first attachment device, said first side, said second side, and said third side of said second rail molded together to form one member, said second side comprising a set of traction devices, said traction devices comprising a central aperture and a series of six circular protrusions, said central aperture and said series of six circular protrusions dispersed along said second side of said second rail, said second rail removeably attached to a flatbed of a truck by inserting in a downward direction said first attachment post and said second attachment post into a first receiving aperture and a second receiving aperture, said second rail being removed by lifting said first attachment post and said second attachment post from within said first receiving aperture and said second receiving aperture, said second rail can be removeably attached to said flatbed of said truck as a first ramp by inserting said first attachment device into a first slot located on a most outer edge of said flatbed of said truck and letting said second rail rest on the ground beside said flatbed of said truck.
